(19) United States
(12) Patent Application Publication
(10) Pub. No.: US 2026/0113207 A1
(43) Pub. Date: Apr. 23, 2026

(54) DATA SEGMENTATION STORAGE METHOD THROUGH PARTICIPATION OF STORAGE NODES

(71) Applicant: ARTIFRIENDS INC., Seongnam-si, Gyeonggi-do (KR)

(72) Inventor: Jung Woo LEE, Daejeon (KR)

(73) Assignee: ARTIFRIENDS INC., Seongnam-si, Gyeonggi-do (KR)

(21) Appl. No.: 18/575,066

(22) PCT Filed: Jun. 29, 2022
(86) PCT No.: PCT/KR2022/009272

§ 371 Date: Dec. 28, 2023

(30) Foreign Application Priority Data
Jun. 30, 2021 (KR) 10-2021-0085986
Jun. 27, 2022 (KR) 10-2022-0077995

(51) Int. Cl. H04L 9/00; H04L 9/32

(52) U.S. Cl. CPC H04L 9/50; H04L 9/3236

(57) ABSTRACT

A data segmentation storage method through participation storage nodes includes steps of a) grouping a certain number of blocks into one group to form generation blocks, which are a block assembly, when the number of blocks in a blockchain reaches a preset certain number, b) dividing data of each block of the generation blocks into transaction data and status data, c) storing status data of a last block of a first generation block in a second generation block in the generation blocks, d) storing status data of a last block of the second generation block in a third generation block in the generation blocks, and e) repeatedly performing processes of storing status data of a last block of an immediately previous generation block in a subsequent generation block on the same principle as a principle of the steps c) and d), up to an Nth generation block.

### TECHNICAL FIELD

The present invention relates to a data segmentation storage method, and more particularly to a data segmentation storage method through participation of storage nodes capable of ensuring serial extension of a blockchain network by segmenting block data into generation block data and constructing a storage node (arbiter) that provides a connection point of each piece of generation block data.

### BACKGROUND ART

Blockchain expansion resulting from increased usage of blockchain has two sides. Experiencing a blockchain expansion problem may be considered as a good phenomenon since it means that the number of transactions on a specific blockchain is rapidly increasing. A reason therefor is that more transactions occurring means that the number of users using the blockchain ultimately increases, which may be described as a reason why the blockchain size of Bitcoin and Ethereum has increased rapidly compared to other blockchain technologies.

Measures against a storage space shortage problem caused by the increase in accumulated data of the existing blockchain technologies, Bitcoin and Ethereum, and unresolved problems related thereto will be examined.

Since data once recorded in a blockchain cannot be arbitrarily changed and is cumulative, the amount of data stored in blocks inevitably continues to increase. In fact, in the case of Bitcoin, the blockchain transaction ledger data capacity alone is close to 187 GB (as of October 2018) and is expected to gradually increase. To solve this problem, data is stored in dual form such that security-critical data is stored on the blockchain and other data, forgery or falsification of which is not significantly important, or sensitive data such as personal information that cannot be deleted when stored on the blockchain and may become a problem in the future is stored outside of the blockchain. In this way, it is predicted that the storage problem of blockchain may be solved. However, this method has not yet been applied.

In the case of Ethereum, the barrier to entry is high since there are storage requirements approaching about 7 TB for basic storage space (based on archive nodes). This storage necessarily requires an SSD (Solid State Drive) due to processing speed issues, so it is difficult to increase the quantity of hardware in terms of hardware cost. To solve this storage space problem, Ethereum is attempting to introduce a method referred to as sharding, which will be briefly described.

Sharding literally means splitting the L1 blockchain into several chains, or shards. In other words, the Ethereum chain is divided into several sub-chains (shards), and then the nodes are divided into groups and placed in one group per shard. In this instance, nodes only need to verify and store transactions of the shards to which the nodes belong. As a result, there are effects in that network burden is reduced and efficiency increases. However, when the processing capacity of a fragmented (sharding) blockchain increases by 10 times, the minimum number of nodes required may increase by 10 times, and thus application of this method is in progress. Here, a little more description will be added with regard to sharding techniques for extending storage space of Ethereum as described above.

FIG. 1 is a diagram schematically illustrating the sharding technique for extending storage space of Ethereum.

Referring to FIG. 1, a beacon chain 110 is the core of Ethereum 2.0 and is a type of blockchain in which validators use a staking system to build a blockchain without a miner.

A shard chain 120 does not process any operation and only performs a function of storing random data. B1 to B5 refer to blocks where random data is stored according to each block capacity.

“Shard 64” 130 refers to the number of shard chains to be introduced in Ethereum 2.0. At the time of introduction, the number was scheduled to be 1024, but the number was adjusted to 64 in Phase 1 by simplifying the structure.

Meanwhile, Korean Patent Publication No. 10-2021-0126453 (Patent Document 1) discloses “blockchain-based distributed data storage device and method for large-capacity data storage.” Accordingly, the blockchain-based distributed data storage method for storing a large amount of data includes a step of inputting and outputting data through a data input/output module configured to input and store data into a distribution module including two or more node storages equipped with local storage or read and output data from the node storages where the data is stored, an encryption/decryption step of encrypting or decrypting the data through an encryption/decryption module when data is input or output to the node storages in the distribution module, and a data analysis and management step of analyzing statuses of the node storages in the distribution module through a data analysis and management module based on data input and output through the data input/output module and efficiently managing data storage in the distribution module using the statuses, and further includes a step of storing/updating, among data input and output each time data is input and output, block data including a location at which the data is stored in the node storages in the distribution module, data required for encryption and decryption in the encryption/decryption module, and data used to determine authority for data input and output in all the node storages in the distribution module in the step of inputting and outputting data.

Patent Document 1 described above has an advantage in that efficiency of data storage may be maximized by reflecting the statuses of nodes where data is stored in real time and learning storage patterns of nodes through artificial intelligence to adjust the number of nodes where duplicate data is stored. However, as the statuses of nodes where data is stored is collected and analyzed, and data storage patterns are learned through artificial intelligence, data processing time inevitably increases, and an operating mechanism of a system contains complex problems.

### DISCLOSURE

### Technical Problem

The present invention has been created by comprehensively considering the above matters, and an object of the present invention is to provide a data segmentation storage method through participation of storage nodes capable of ensuring serial extension of a blockchain network by dividing data of each block in a blockchain into status data and transaction data, dividing block data into generation block data, constructing an arbiter configured to act as a storage node that provides a connection point for each piece of generation block data.

### TECHNICAL SOLUTION

To achieve the above object, a data segmentation storage method through participation of storage nodes according to an embodiment of the present invention is
a method of segmenting and storing data through participation of storage nodes in a blockchain having each step performed by a computer system, and includes steps of
a) grouping a certain number of blocks into one group to form generation blocks, which are a block assembly, when the number of blocks in a blockchain reaches a preset certain number,
b) dividing data of each block of the generation blocks into transaction data and status data,
c) storing status data of a last block of a first generation (Generation 1) block in a second generation (Generation 2) block in the generation blocks,
d) storing status data of a last block of the second generation (Generation 2) block in a third generation (Generation 3) block in the generation blocks, and
e) repeatedly performing a series of processes of storing status data of a last block of an immediately previous generation block in a subsequent generation block on the same principle as a principle of the steps c) and d), up to an Nth generation block.

Here, the method may further include verifying and synchronizing the generation blocks by entrants to a new blockchain network after the step e).

In this instance, the verifying and synchronizing the generation blocks by entrants to a new blockchain network may include verifying and synchronizing all generation blocks from the first generation (Generation 1) block to an Nth generation (Generation N) block or verifying and synchronizing blocks from status data of a last generation block.

In addition, the certain number of blocks may be 256 in the step a).

In addition, when the data of each block is divided into transaction data and status data in the step b), pieces of transaction data of each block, the number of which has become greater than or equal to a certain number, may be cut as one bundle and divided as a generation block, and status values of the divided status may be divided as status data.

In addition, the step b) may include designating the status data as data necessary for contract processing.

In addition, when an arbiter is designated to serve as a storage node that stores a current generation block and provides a connection point for each piece of generation block data in the steps c) to e), blockchain network participants may be given authority to delete block data corresponding to a previous generation block.

In this instance, validator nodes that operate a blockchain network may construct and operate an arbiter according to needs thereof.

In addition, to achieve the above object, a data segmentation storage method through participation of storage nodes according to another embodiment of the present invention is
a method of segmenting and storing data through participation of storage nodes in a blockchain having each step performed by a computer system, and includes steps of
a) grouping a certain number of blocks into one group to form generation blocks, which are a block assembly, when the number of blocks in a blockchain reaches a preset certain number,
b) dividing data of each block of the generation blocks into transaction data and status data, and
c) storing status data of a last block of an nth generation block in an (n+1)th generation block in the generation blocks.

Here, the method may further include a step of verifying and synchronizing the generation blocks by entrants to a new blockchain network.

### ADVANTAGEOUS EFFECTS

According to the present invention, there is an advantage in that it is possible to ensure serial extension of a blockchain network by dividing data of each block in a blockchain into status data and transaction data, dividing block data into generation block data, and constructing an arbiter configured to act as a storage node that provides a connection point for each piece of generation block data.

### DESCRIPTION OF DRAWINGS

FIG. 1 is a diagram schematically illustrating sharding technique for extending storage space of Ethereum.

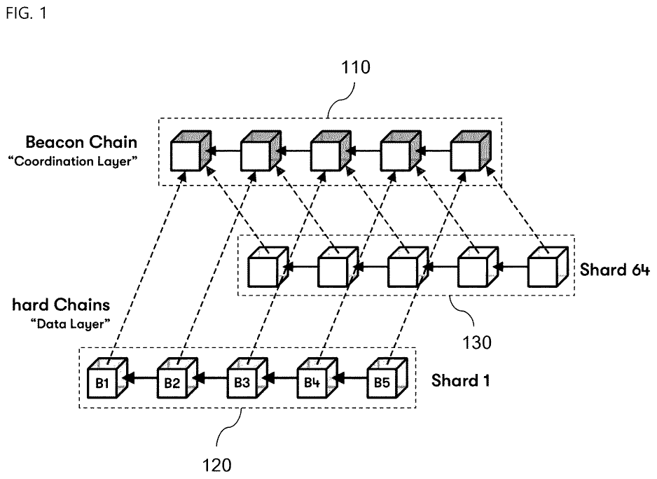

FIG. 2 is a flowchart illustrating an execution process of a data segmentation storage method through participation of storage nodes according to an embodiment of the present invention.

FIG. 3 is a flowchart illustrating a block data structure of SASEUL employed in the data segmentation storage method through participation of storage nodes according to the present invention.

FIG. 4 is a flowchart illustrating an execution process of a data segmentation storage method through participation of storage nodes according to another embodiment of the present invention.

### MODE FOR INVENTION

Terms or words used in this specification and claims should not be construed as limited to ordinary or dictionary meanings, and should be interpreted as having meanings and concepts consistent with the technical idea of the present invention based on the principle that an inventor may appropriately define a concept of a term in order to describe the invention in the best way possible.

Throughout the specification, when a part “includes” a certain element, this means that another element may be further included rather than excluding another element unless specifically stated to the contrary. In addition, terms such as “. . . unit,” “. . . device,” “module,” and “device” used in the specification refer to a unit that processes at least one function or operation, which may be implemented as hardware, software, or a combination of hardware and software.

Hereinafter, embodiments of the present invention will be described in detail with reference to the attached drawings.

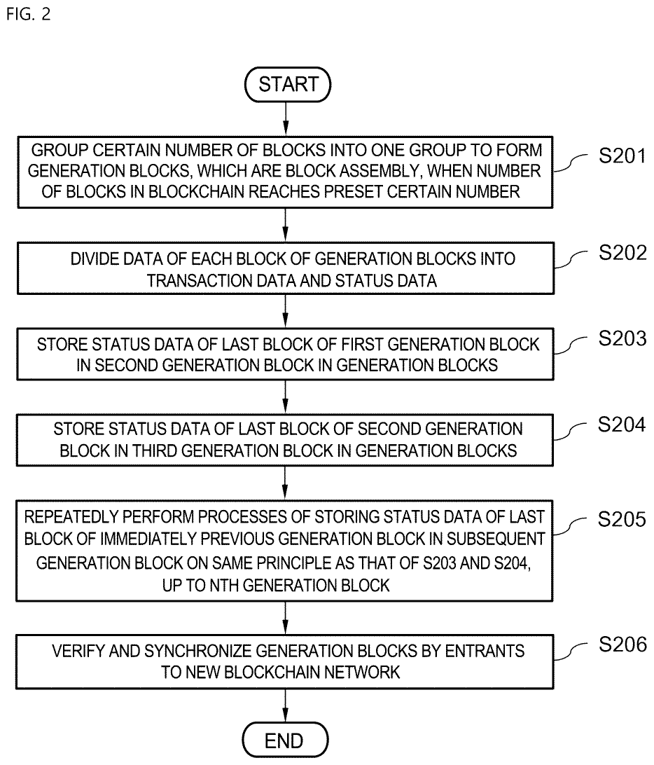

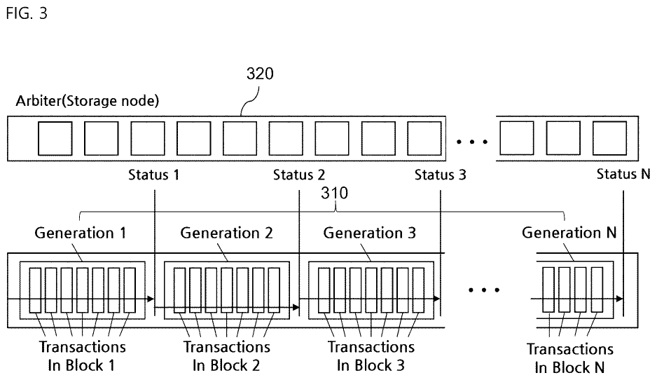

FIG. 2 is a flowchart illustrating an execution process of a data segmentation storage method through participation of storage nodes according to an embodiment of the present invention, and FIG. 3 is a flowchart illustrating a block data structure of SASEUL employed in the data segmentation storage method through participation of storage nodes according to the present invention.

Referring to FIGS. 2 and 3, in the data segmentation storage method through participation of storage nodes according to the embodiment of the present invention, each step is performed by a computer system. As a method of dividing and storing data through participation of storage nodes in a blockchain, first, when the number of blocks in the blockchain reaches a preset certain number, the certain number of blocks is grouped into one group to form generation blocks 310, which are a block assembly (step S201). Here, the certain number of blocks may be 256.

When formation of the generation blocks 310 is completed in this way, as shown in FIG. 3, data of each block of the generation blocks 310 is divided into transaction data and status data (step S202). Here, when the data of each block is divided into transaction data and status data, pieces of transaction data of each block, the number of which has become greater than or equal to a certain number (for example, 256), may be cut as one bundle and divided as a generation block as described above, and status values of the divided status may be divided as status data (status 1 to status N). Here, the status data (status 1 to status N) may be designated as data necessary for contract processing.

After dividing the data of each block into transaction data and status data as described above, in the generation blocks 310, status data of a last block of a first generation (Generation 1) block is stored in a second generation (Generation 2) block (step S203).

Likewise, in the generation blocks 310, status data of a last block of the second generation (Generation 2) block is stored in a third generation (Generation 3) block (step S204).

Thereafter, a series of processes of storing status data of a last block of an immediately previous generation block in a subsequent generation block are repeatedly performed on the same principle as that of steps S203 and S204, up to an Nth generation block (step S205).

The data segmentation storage method through participation of storage nodes according to an embodiment of the present invention as described above may further include a step S206 in which entrants to a new blockchain network verify and synchronize the generation blocks 310 after step S205.

In this instance, when the entrants to the new blockchain network verify and synchronize the generation blocks 310, the entrants may verify and synchronize all generation blocks from the first generation (Generation 1) block to the Nth generation (Generation N) block, or may verify and synchronize blocks from status data of the last generation block (here Generation N).

In addition, in steps S203 to S205, when an arbiter 320 is designated to serve as a storage node that stores a current generation block and provides a connection point for each piece of generation block data, blockchain network participants may be given the authority to delete block data corresponding to the previous generation block.

In this instance, validator nodes that operate the blockchain network may construct and operate an arbiter according to needs thereof.

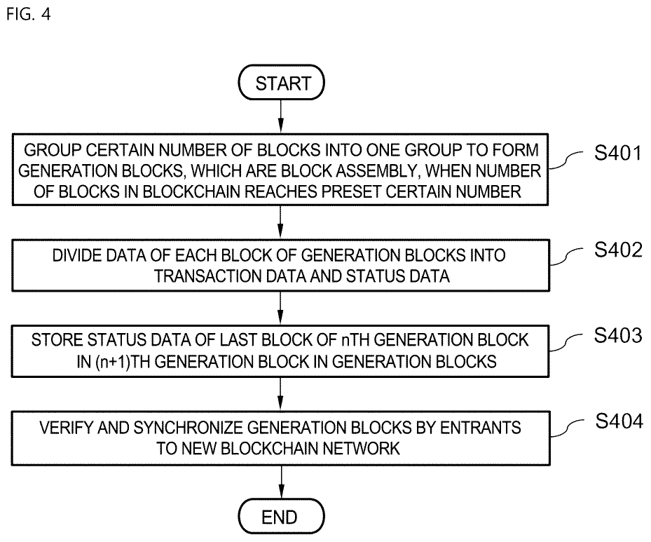

Meanwhile, FIG. 4 is a flowchart illustrating an execution process of a data segmentation storage method through participation of storage nodes according to another embodiment of the present invention.

Referring to FIG. 4, each step of the data segmentation storage method through participation of storage nodes according to another embodiment of the present invention is performed by a computer system. As a method of dividing and storing data through participation of storage nodes in a blockchain, first, when the number of blocks in the blockchain reaches a preset certain number, the certain number of blocks is grouped into one group to form generation blocks 310, which are a block assembly (see FIG. 3) (step S401).

Thereafter, data of each block of the generation blocks 310 is divided into transaction data and status data (step S402).

Here, steps S401 and S402 described above are the same as steps S201 and S202 of FIG. 2 referenced while describing the first embodiment, and thus detailed descriptions related to steps S401 and S402 will be replaced with descriptions related to steps S201 and S202 above.

As described above, after dividing the data of each block into transaction data and status data, status data of a last block of an nth generation (Generation n) block is stored in an (n+1)th generation (Generation n+1) block in the generation blocks 310 (step S403). For example, status data of a last block of a 15th generation (Generation 15) block is stored in a 16th generation (Generation 16) block and status data of a last block of a 119th generation (Generation 119) block is stored in a 120th generation (Generation 120) block.

The data segmentation storage method through participation of storage nodes according to another embodiment of the present invention described above may further include a step S404 in which entrants to a new blockchain network verify and synchronize the generation blocks 310.

As described above, the data segmentation storage method through participation of storage nodes according to the present invention has an advantage of ensuring serial extension of a blockchain network by dividing data of each block in a blockchain into status data and transaction data, dividing block data into generation block data, and constructing an arbiter serving as a storage node that provides a connection point of each piece of generation block data.

Even though the present invention has been described above in detail through preferred embodiments, the present invention is not limited thereto, and it is obvious to those skilled in the art that various changes and applications may be made without departing from the technical spirit of the present invention. Therefore, the true scope of protection of the present invention should be interpreted in accordance with the following claims, and all technical ideas within the equivalent scope should be interpreted as being included in the scope of rights of the present invention.

1. A data segmentation storage method through participation of storage nodes, which is a method of segmenting and storing data through participation of storage nodes in a blockchain, each step of the method being performed by a computer system, the method comprising steps of:
a) grouping a certain number of blocks into one group to form generation blocks, which are a block assembly, when the number of blocks in a blockchain reaches a preset certain number;
b) dividing data of each block of the generation blocks into transaction data and status data;
c) storing status data of a last block of a first generation (Generation 1) block in a second generation (Generation 2) block in the generation blocks;
d) storing status data of a last block of the second generation (Generation 2) block in a third generation (Generation 3) block in the generation blocks; and
e) repeatedly performing a series of processes of storing status data of a last block of an immediately previous generation block in a subsequent generation block on the same principle as a principle of the steps c) and d), up to an Nth generation block.

2. The method according to claim 1, further comprising a step of verifying and synchronizing the generation blocks by entrants to a new blockchain network after the step e).

3. The method according to claim 2, wherein the verifying and synchronizing the generation blocks by entrants to a new blockchain network comprises verifying and synchronizing all generation blocks from the first generation (Generation 1) block to an Nth generation (Generation N) block or verifying and synchronizing blocks from status data of a last generation block.

4. The method according to claim 1, wherein the certain number of blocks is 256 in the step a).

5. The method according to claim 1, wherein, when the data of each block is divided into transaction data and status data in the step b), pieces of transaction data of each block, the number of which has become greater than or equal to a certain number, is cut as one bundle and divided as a generation block, and status values of the divided status are divided as status data.

6. The method according to claim 1, wherein the step b) comprises designating the status data as data necessary for contract processing.

7. The method according to claim 1, wherein, when an arbiter is designated to serve as a storage node that stores a current generation block and provides a connection point for each piece of generation block data in the steps c) to e), blockchain network participants are given authority to delete block data corresponding to a previous generation block.

8. The method according to claim 7, wherein validator nodes that operate a blockchain network construct and operate an arbiter according to needs thereof.

9. A data segmentation storage method through participation of storage nodes, which is a method of segmenting and storing data through participation of storage nodes in a blockchain, each step of the method being performed by a computer system, the method comprising steps of:
a) grouping a certain number of blocks into one to form generation blocks, which are a block assembly, when the number of blocks in a blockchain reaches a preset certain number;
b) dividing data of each block of the generation blocks into transaction data and status data; and
c) storing status data of a last block of an nth generation block in an (n+1)th generation block in the generation blocks.

10. The method according to claim 9, further comprising a step of verifying and synchronizing the generation blocks by entrants to a new blockchain network.
